(19) United States
(12) Patent Application Publication
(10) Pub. No.: US 2015/0060532 A1
(43) Pub. Date: Mar. 5, 2015

(54) Food Product Holder

(71) Applicant: Ward J. Goldstein, Simi Valley, CA (US)

(72) Inventor: Ward J. Goldstein, Simi Valley, CA (US)

(21) Appl. No.: 14/457,269

(22) Filed: Aug. 12, 2014

Related U.S. Application Data
(60) Provisional application No. 61/871,213, filed on Aug. 28, 2013.

(51) Int. Cl. A47G 21/00; B31B 1/90; B31B 1/26; B65D 77/02; B31B 1/25

(52) U.S. Cl. CPC A47G 21/001; B65D 77/02; B31B 1/25; B31B 1/26; B31B 1/90
USPC 229/87.08; 493/295; 493/288; 493/291

(57) ABSTRACT

A holder for a food product includes three rectangular shaped sidewalls which are interconnected to establish a triangular tube-like structure with an enclosed space for receiving a portion of the food product therein. A score line is formed on a selected sidewall to create an integral hinge which allows for an operational reconfiguration of the holder to support the food product while the food product is being consumed.

This application claims the benefit of U.S. Provisional Patent Application Ser. No. 61/871,213, filed Aug. 28, 2013. The entire contents of Application Ser. No. 61/871,213 are hereby incorporated by reference herein.

### FIELD OF THE INVENTION

The present invention pertains generally to disposable food product holders. More particularly, the present invention pertains to food holders for supporting cone-shaped food products. The present invention is particularly, but not exclusively, useful as a hollow, triangular shaped, tube-like structure which is manipulable and reconfigurable to engage with and hold a portion of a food product during consumption of the food product.

### BACKGROUND OF THE INVENTION

Hand-held food products that are ready-to-eat will typically require some form of support structure for the food product during its consumption. A paper plate or a basket are each an example of such a support structure.

Plates and baskets, however, normally require a two-handed operation, and in some circumstances they may be unwieldy. Thus, it is easy to consider several instances wherein a single-handed eating experience may be preferable, and more appropriate. An ice cream cone is just one example of such a circumstance. The ability to eat single-handedly becomes further complicated with more sophisticated food products, such as chili, casseroles, or a blend of foods. Nevertheless, an ability to eat with only one hand may still be very desirable.

An important aspect of the present invention is the ability of the holder to fit various beverage holders, such as the beverage holders in cars, trucks, the seats beverage holders in stadiums, sports arenas, movie theaters, or any standard size beverage holders designed to hold drinks. The other very import thing about the holder is that the triangular shape and the size of it fits exactly into the most common to-go beverage holders that are used by most stadiums, sports arenas, theme parks, entertainment centers, restaurants, convenience stores, and concessions. With its design, each point of the triangle fits securely into the three vertical slots or slits that exist in these beverage carriers. It fits so firmly that a person can easily walk carrying their food securely in an upright position in each space that was originally designed to hold beverages.

In light of the above it is an object of the present invention to provide a food product holder that will operationally support the food product during a single-handed eating experience. Another object of the present invention is to provide a food product holder that can be easily reconfigured for convenient adaptation and conformation with the food product. Still another object of the present invention is to provide a food product holder that is easy to use, is simple to manufacture, and is comparatively cost effective.

### SUMMARY OF THE INVENTION

In accordance with the present invention a food product holder is created for holding and supporting a cone-shaped food product in a variety of different situations. Of particular interest are situations wherein the user/consumer desires to temporarily release control over the food product for an indeterminate period of time, without somehow compromising the integrity of the food product. For this purpose, as envisioned for the present invention, the food product holder can be used to safely support the food product on a counter or some other level surface, on a carrier tray, or in a vehicle accessory such as a drink holder. On the other hand, when it is desired to have the food product under direct control of the user/consumer, the food product holder of the present invention can be easily held and manipulated by the user/consumer during transfer or consumption of the food product.

Structurally, the food product holder of the present invention is a hollow, elongated, open-ended, tube-like unit. In particular, the unit creates an enclosed space that is bounded and defined by a plurality of flat outer sidewalls. Preferably, these sidewalls establish a triangular cross-section for the enclosed space that can be manipulated and deformed, during use by the user/consumer, to securely hold the food product.

In structural detail, each sidewall of the food product holder is quadrilateral, and it has a first end and a second end, with opposing edges that extend between the first and second ends. Further, each edge of each sidewall is connected with the edge of another sidewall by a hinge-like fold line. In combination, the sidewalls are contiguous, and they collectively establish and define the enclosed space for receiving at least a portion of the food product.

Additionally, a score line can be formed on one of the sidewalls. Preferably, this score line will be located midway between the edges of a selected sidewall and it will extend between the first and second ends of the selected sidewall to create an integral hinge which will facilitate movement of the holder between a first and a second configuration. Specifically, due to the score line, the food product holder can be easily manipulated to collapse the food product holder onto the food product as the food product is being held in the enclosed space of the food product holder.

For the manufacture of a food product holder in accordance with the present invention, a pattern is cut from a sheet of material. Preferably, the material is either a relatively stiff paper product or a semi-flexible cardboard. Notches are then formed into the pattern to create fold lines which will delineate the pattern into a contiguous sequence of sidewalls, with a tab. Functionally, the fold lines allow the sidewalls to rotate around a connecting fold line relative to each other. For purposes of the present invention, these fold lines can be formed by any means well known in the pertinent art, such as by creasing, crimping or scoring the material.

When the notches have been formed on the pattern of material, the sequence of sidewalls will also include a tab. As intended for the present invention, the fold lines will sequentially create a tab, a connecting sidewall, an intermediate sidewall, and an end sidewall. In this sequence, the connecting sidewall is positioned between the tab and the intermediate sidewall, and the intermediate side wall is positioned between the connecting sidewall and the end sidewall. Further, the fold lines are mutually parallel to each other, and all of the sidewalls are substantially rectangular. In a preferred embodiment of the present invention, the tab, which is connected directly via a fold line with the connecting sidewall, may be formed with a diminishing taper in a direction away from the connecting sidewall.

As indicated above, during the notching process that is used to create the fold lines on the pattern, a selected sidewall (preferably the intermediate sidewall) is further formed with a score line. This score line is oriented substantially parallel to the fold lines, and is provided to divide the intermediate sidewall into a pair of opposed panels that straddle the score line.

In a final assembly of the food product holder, the tab is affixed to the end sidewall by any means well known in the pertinent art, such as by using glue. The result then is a hollow, elongated, open-ended, tube-like food product holder which has an enclosed space that is bounded by a plurality of sidewalls for receiving a portion of the food product therein. As envisioned for the present invention, the food product holder will preferably have three sidewalls, and the enclosed space that is created will have a triangular cross-section. The present invention, however, envisions that additional sidewalls may be created.

With the above in mind, it is to be appreciated that prior to their assembly, the originally flat patterns of the present invention are ready to be economically transported to a destination. Further, even after assembly, but prior to use, a food product holder can be folded along the score line to completely collapse the enclosed space and thereby establish a flat configuration for convenient, on-site storage of the food product holder.

### DESCRIPTION OF THE DRAWINGS

FIG. 1 is a is an exploded perspective view of a food product holder of the present invention with a food product shown positioned for placement on the holder;

FIG. 2 is a perspective view of a food product holder in use, holding a food product;

FIG. 3A is a top view of the food product holder when in a first configuration as seen along the line 3-3 in FIG. 1;

FIG. 3B is a top view of the food product holder when in a second configuration as would be seen along the line 3-3 in FIG. 1 after being manipulated by a consumer to hold the food product;

FIG. 4 is a view of the food product holder prior to assembly; and

FIG. 5 is a view of the food product holder during assembly.

### DESCRIPTION OF THE PREFERRED EMBODIMENTS

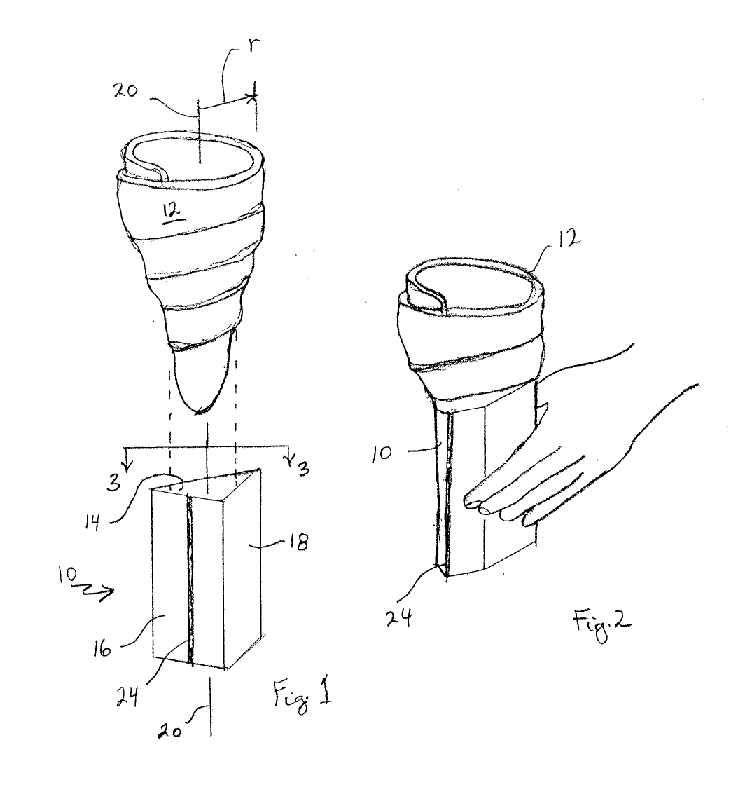

Referring initially to FIG. 1 a food product holder in accordance with the present invention is shown, and is generally designated 10. Referring to both FIG. 1 and FIG. 2, it will be appreciated that the holder 10 is used to receive a cone-shaped food product 12 for support and handling of the food product 12 during consumption of the food product 12 by a user. For purposes of the present invention, the food product 12 is considered to be a bread-like structure which is formed as a hollow cone having an opening radius r.

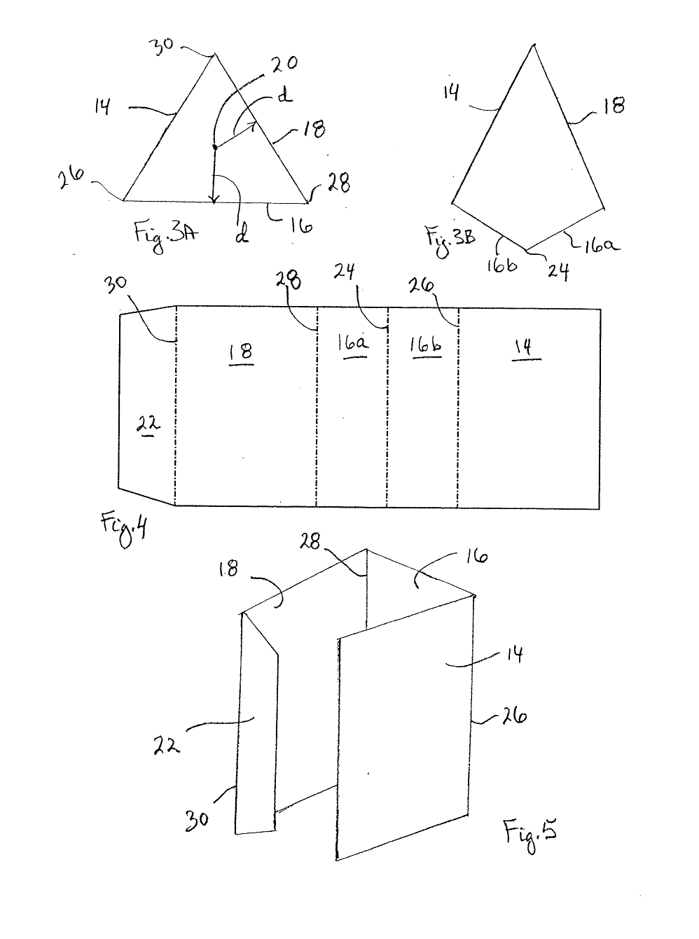

As shown in FIG. 1, the holder 10 of the present invention essentially includes an end sidewall 14, an intermediate sidewall 16 and a connecting sidewall 18. The sidewalls 14, 16 and 18 are all contiguous with each other, and they are all substantially rectangular shaped. Further, when connected with each other, the sidewalls 14, 16 and 18 are shown to surround a central axis 20. In FIG. 3A the connected sidewalls 14, 16 and 18 are shown in a base configuration to form an isosceles triangle, wherein each of the connected sidewalls 14, 16 and 18 are at a distance d from the central axis 20. In the relationship between the holder 10 and the food product 12, d is less than r (d<r). For the present invention, the holder 10 will preferably be made of a structurally strong paper stock, of a type well known in the pertinent art.

Referring now to FIG. 4 it will be seen that the food product holder 10 also includes a tab 22 that is located adjacent the connecting sidewall 18. Further, it will be seen that a score line 24 is formed on the intermediate sidewall 16. Importantly, this score line 24 acts as a so called integral “living hinge” which allows the respective sidewall panels 16a and 16b of the intermediate sidewall 16 to rotate relative to each other around the score line 24.

Also shown in FIG. 4 are a sequence of hinge-like fold lines 26, 28 and 30. In detail, the hinge-like fold line 26 separates the end sidewall 14 from the intermediate sidewall 16; the hinge-like fold line 28 separates the intermediate sidewall 16 from the connecting sidewall 18; and the hinge-like fold line 30 separates the connecting sidewall 18 from the tab 22. The consequence here is that the connected sidewalls 14, 16 and 18, and tab 22, can be folded along the various fold lines 26, 28 and 30 as shown in FIG. 5. The tab 22 can then be affixed to the end sidewall 14 to form the holder 10. As envisioned for the present invention, tab 22 can be affixed to the end sidewall 14 in any manner well known in the pertinent art, such as by gluing them together.

With the structure for a holder 10 as disclosed above, it will be appreciated that it is possible to selectively move the holder 10 between a first configuration (see FIG. 3A) and a second configuration (see FIG. 3B). To do this, the holder 10 is manipulated by a user to fold the intermediate sidewall 16 along the score line 24. This will effectively collapse the holder 10 into its second configuration. Importantly, in its second configuration the holder 10 essentially conforms with the food product 12, to thereby support and hold a portion of the food product 12 as it is being consumed by a user.

While the particular Food Product Holder as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A holder for a food product which comprises:
a plurality of sidewalls, wherein each sidewall is quadrilateral and has a first end and a second end with opposite edges extending between the first and second ends, wherein each edge of a sidewall is connected with the edge of another sidewall to establish an enclosed space bounded by the plurality of sidewalls for receiving a portion of the food product therein; and
a score line formed on a selected sidewall, wherein the score line is located midway between the edges of the selected sidewall and extends between the first and second ends thereof to create an integral hinge thereon for movement of the holder between a first configuration and a second configuration when the holder is manipulated to fold the selected sidewall along the score line and effectively collapse the holder into the second configuration and onto the food product for supporting the food product while a portion of the food product is in the enclosed space of the holder.

2. A holder as recited in claim 1 wherein the food product is made of bread and is formed as a hollow cone, and wherein a circular opening into the cone-shaped food product has a radius r.

3. A holder as recited in claim 2 wherein the enclosed space defines a central axis when the holder is in the first configuration, and each sidewall is at a distance d from the central axis, with d being less than r (d<r).

4. A holder as recited in claim 1 wherein there are three sidewalls.

5. A holder as recited in claim 4 wherein the three sidewalls form an isosceles triangle.

6. A holder as recited in claim 4 wherein the sidewalls are rectangular.

7. A holder as recited in claim 1 wherein the holder is made of paper.

8. A method for manufacturing a holder for a food product which comprises the steps of:
cutting a pattern from a sheet of material;
forming notches into the pattern to create fold lines for delineating the pattern into a contiguous sequence including a tab, a connecting sidewall, an intermediate sidewall, and an end sidewall, wherein the connecting sidewall is positioned between the tab and the intermediate sidewall, and the intermediate side wall is positioned between the connecting sidewall and the end sidewall, and wherein the fold lines are mutually parallel and all sidewalls are substantially rectangular;
scoring the intermediate sidewall with a score line parallel to the fold lines, to divide the intermediate sidewall into a pair of panels astraddle the score line; and
affixing the tab to the end sidewall to establish an enclosed space bounded by the plurality of sidewalls for receiving a portion of the food product therein.

9. A method as recited in claim 8 wherein the material is paper.

10. A method as recited in claim 8 wherein the tab is formed with a diminishing taper in a direction away from the connecting sidewall.

11. A method as recited in claim 8 wherein the attaching step is accomplished using a glue.

12. A holder for a cone-shaped food product which comprises:
an end sidewall having a first end and a second end with opposite edges extending between the first and second ends;
an intermediate sidewall having a first end and a second end with opposite edges extending between the first and second ends;
a connecting sidewall having a first end and a second end with opposite edges extending between the first and second ends; and
a tab, wherein the tab is connected to an edge of the connecting sidewall by a hinge-like fold line and is affixed to the end sidewall to align an edge of the connecting side wall with an edge of the end sidewall, and wherein opposite edges of the intermediate sidewall are respectively connected by a hinge-like fold line to the edge of the connecting sidewall, opposite the tab, and by a hinge-like fold line to the edge of the end sidewall, across the sidewall from the tab to establish an enclosed space bounded by the sidewalls for receiving a portion of the food product therein.

13. A holder as recited in claim 12 further comprising a score line formed on a selected sidewall, wherein the score line is located midway between the edges of the selected sidewall and extends between the first and second ends thereof to create an integral hinge thereon for movement of the holder between a first configuration and a second configuration when the holder is manipulated to fold the selected sidewall along the score line and effectively collapse the holder into its second configuration and onto the food product for supporting the food product while a portion of the food product is in the enclosed space of the holder.

14. A holder as recited in claim 13 wherein the food product is made of bread and is formed as a hollow cone, and wherein a circular opening into the cone-shaped food product has a radius r.

15. A holder as recited in claim 14 wherein the enclosed space defines a central axis when the holder is in the first configuration, and each sidewall is at a distance d from the central axis, with d being less than r (d<r).

16. A holder as recited in claim 15 wherein the three sidewalls form an isosceles triangle.

17. A holder as recited in claim 15 wherein the sidewalls are rectangular and an equidistant from the central axis.

18. A holder as recited in claim 12 wherein the holder is made of paper.
